(19) United States
(12) Patent Application Publication
(10) Pub. No.: US 2010/0050850 A1
(43) Pub. Date: Mar. 4, 2010

(54) METHOD FOR IMPROVING THE SOUND OF MUSICAL INSTRUMENTS

(76) Inventor: Hans-Ulrich Rahe, Bad Salzdetfurth (DE)

Correspondence Address: FISH & RICHARDSON PC, P.O. BOX 1022, MINNEAPOLIS, MN, 55440-1022, US

(21) Appl. No.: 12/439,817

(22) PCT Filed: Aug. 29, 2007
(86) PCT No.: PCT/EP2007/058980

§ 371 Date: Mar. 3, 2009

(30) Foreign Application Priority Data
Sep. 4, 2006 (EP) 06018419.9

(51) Int. Cl. G10C 1/00

(52) U.S. Cl. 84/174

(57) ABSTRACT

Disclosed is a method for improving the sound of acoustic musical instruments by suppressing energy storage effects resulting in undesired interferences and distorted sounds. This is done by specifically directing the sound energy (kinetic disposal) away from parts not directly required for generating sound before the sound energy can influence the desired, primary sound event of the musical instrument. In a second aspect, the lowest energy level for generating sound, and thus the optimal initial state of all instrument parts required for creating the primary sound event, is restored as quickly as possible by means of said kinetic disposal. The kinetic disposal is obtained by arranging at least one crystalline member (1) that has a sound velocity of more than 8000 m/s in the solid, on a part (5) located in the passive zone of the musical instrument.

### TECHNICAL FIELD

The invention relates to a method for improving the sound of musical instruments. It particularly relates to a method for reducing sound emission and/or reducing energy storage effects of the passive region of musical instruments. Finally, a new type of musical instrument is also indicated with the invention.

In the sense of this invention, the “passive region” of a musical instrument is to be understood as those components or regions of components that are not directly required for sound production. Examples of such components are, for example in the case of a grand piano or piano: the cast iron plate on which the strings are strung; in the case of a violin: the neck; in the case of a kettledrum: the corpus on which the membrane is stretched, etc.

In contrast to this, the “active region” of a musical instrument in the sense of this invention is understood to mean those components or regions of components that are directly necessary for sound production, such as the strings of a piano/grand piano, or of a violin, the reed of a clarinet, etc.

Furthermore, the terms “primary sound event” and “secondary sound event” will be used below to explain the invention, and are to be understood as follows: A primary sound event is one that is brought about by the vibrations of the components of the active region or of the active region of a component, in other words the sound event that is actually intended, in the foreground, for the sound of the musical instrument. In contrast, the secondary sound event is understood to be the sound event produced by vibrations of the components of the passive region of the musical instrument, which helps to determine the overall sound, as the result of superimposition on the primary sound event.

### STATE OF THE ART

In traditional instrument construction, the influence of secondary sound events on the primary sound event is understood to be an essentially unavoidable, integral part of the overall sound.

Explained using the example of pianos and grand pianos (see FIGS. 1 and 2), this means: The soundboard 13 is connected with the rest of the corpus (grand piano frame 6 and wall 7), and in this way with all the components of the instrument, so as to conduct sound. This means that all the parts of the instrument are excited to vibrate by means of the primary sound event, i.e. by the vibrations of the active region, which consists of strings, bridge 14, and soundboard 13.

The same fundamental principle also applies for all other musical instruments: in the case of bowed and plucked instruments, for example, because of the sound-conducting connection of the soundboard with the frame and the instrument neck; in the case of wind instruments, because of the sound-conducting connection of the mouthpiece with the barrel; in the case of percussion instruments, because the membrane is stretched onto a frame, which in turn is connected with the corpus in sound-conducting manner, etc.

As a result, very complex interference patterns and phase shifts come about, resulting from running time differences and different resonance characteristics of the individual components. The end result is an overall sound for which it holds true that, while it is dominated by the primary sound event emitted by the soundboard 13, its undistorted purity, clarity, and dynamics are distorted, covered up, and blurred by the numerous, complex interferences.

There have been attempts, again and again, particularly in piano and grand piano construction, to reduce disruptive sound events. For example, the cast iron plate 5 was provided with large sound openings, for example, and an attempt was made to eliminate cast iron plate ribs. Grand piano casters 11 or coasters were specially designed (in most cases as spring or air cushion systems), in order to uncouple the grand piano from the floor. However, in all these efforts, all the components of the piano or grand piano have fundamentally remained connected with one another, in sound-conducting manner, up to the present.

Coupling of the musical instrument to its surroundings by means of contact with the floor, for example by means of the casters 11 in the case of a grand piano or piano, the endpin in the case of a cello or contrabass, the stands in the case of drums, kettledrums, or harps, and the like, necessary leads to additional resonance phenomena.

Furthermore, in this connection, energy storage effects of the individual components are considered to be essentially unavoidable. The energy storage effect is understood to be the following phenomenon: When a sound event is triggered, the sound energy spreads out in the entire instrument as a process over time. Since the components are “at rest” up to this point in time, every component is first saturated with this sound energy that flows into it, before radiation of the energy excess into components connected in sound-conducting manner and into the surrounding air comes about. In the case of the active components (in a grand piano/piano, for example, strings, bridge 14, and soundboard 13), this effect is desirable and necessary. In the passive components, however, which are of no importance for the primary sound event, the sound energy that gets into them, at a different proportion from one component to another, leads to phase shifts and thus to interferences with the primary sound event.

What makes the situation more difficult is that during normal play of a musical instrument, many independent and different primary sound events are triggered at very short time intervals. These events furthermore overlap in multi-voice playing. The components of the instrument are therefore normally not at rest when a new sound event arrives, but rather are still vibrating from the previous event. While these events are still partly desired in the soundboard, since immediate radiation of the entire sound energy into the air as a medium would make the sound exist for only an undesirably short period of time, these effects have extremely negative influences on the primary sound event that has the secondary sound events imposed on it, in the case of all the other (passive) components.

Only in very rare cases are precious stones in settings, particularly diamonds, attached to instruments with this setting, (http://web.archive.org/web/20060112103518/http://www.frankundmeyer.d e/) or semi-precious stones, affixed to instruments for improving the resonance

(http://web.archive.org/web/20060205164408/http://cannonballmusic.com/stonelion.php).

### PRESENTATION OF THE INVENTION

It is therefore the task of the invention to indicate a method with which the effect of secondary sound events on the primary sound event can be prevented or reduced, particularly in that the occurrence of secondary sound events is prevented, or the latter are at least clearly reduced in intensity.

This task is accomplished, in general, with the characteristics of claim 1. Further developments that are advantageous for this method are indicated in the dependent claims 2 to 8.

Finally, in claim 9, use of a crystalline body, according to the invention, having a sound velocity in the solid body of more than 8,000 m/s, for influencing the sound of musical instruments, is disclosed, and in claim 10, a musical instrument equipped with such a crystalline body, according to the invention, is claimed.

According to the invention, the crystalline bodies are connected with the components of the musical instruments for which kinetic disposal is required, i.e. with the passive regions of such components, by means of a fixed, direct connection; in particular, they are glued into them or set into them.

The significant aspect of the invention lies in the recognition that it is possible to pass sound energy out of a musical instrument using an effect that is referred to as “kinetic disposal” here.

Within the scope of this invention, kinetic disposal is understood to be the direct dissipation of the energy that has passed from the active region of a musical instrument into the passive (ideally non-moving) regions (these are all the other parts of the instrument), into the space that surrounds the instrument, before energy storage effects occur in the instrument. In this connection, dissipation into the surrounding space takes place by means of transformation of the energy to a plane that is sound energy that can no longer be heard.

In a first aspect, kinetic disposal can take place, on a component that can be assigned to the passive region of the musical instrument, as a whole, in order to avoid energy storage effects that occur in this component, and the negative feedback on the current or possibly subsequent primary sound event that these effects might have (see claim 2).

In accordance with the method according to the invention, the crystalline body can just as well be used in a passive region of a component that is also equipped with an active region. In this way, acoustic energy that would otherwise be stored in the passive region of the component is prevented from flowing back into the active region and impairing the sound of the subsequent primary sound event.

Kinetic disposal is achieved, according to the invention, in that a crystalline body made of a material having a high sound velocity in the solid body (sound velocity of more than 8,000 m/s) is disposed on the components of the passive region that are not required for production of the primary sound event, or on the passive region of a component of the instrument that also has an active region, in order to reduce their emission of sound to the surroundings, if possible to eliminate it, to a great extent, and in order to reduce or avoid its subsequent vibration.

The deciding factor for the effect of the crystalline body used according to the invention is that a potential of sound velocities must be present between it and the material of the component for which kinetic disposal is required. The material used for kinetic disposal must always have a greater sound velocity than the material for which disposal is required. The greater the potential, the clearer the effect (see Table 1).

For kinetic disposal of components of musical instruments, the degree of kinetic disposal (pass-through factor) results from the ratio of the sound velocities of the two materials. When a diamond is used for kinetic disposal of the cast iron plate of a grand piano (which consists of gray cast iron), for example, a pass-through factor of approximately 4:1 is obtained (18,000 m/s:4,500 m/s). The materials that are typically used in musical instrument construction and for which kinetic disposal is required are wood, gray cast iron, brass, and the like, all of whose sound velocities lie between approximately 3,000 and 5,000 m/s. Thus, there is a sufficient potential relative to materials whose sound velocities amount to at least 8,000 m/s so that these can have a kinetic disposal effect.

TABLE 1
Table 1: Degree of kinetic disposal,
with air as the reference variable

| | | |
|---|---|---|
| Material | Sound velocity | Pass-through factor |

| | | | |
|---|---|---|---|
| Diamond | approx. 18,000 | m/s | approx. 50:1 |
| Boron carbide | 14,400 | m/s | approx. 42:1 |
| Aluminum oxide | approx. 10,000 | m/s | approx. 30:1 |
| Spruce wood | approx. 5,500 | m/s | approx. 15:1 |
| Gray cast iron | approx. 4,500 | m/s | approx. 13:1 |
| Brass | 3,400 | m/s | 10:1 |
| Water | 1,481 | m/s | approx. 4:1 |
| Air | 340 | m/s | 1:1 |

By means of kinetic disposal, it is clearly possible to dissipate the body and air sound energy that has gotten into the passive region of the instrument, almost instantaneously, and as energy that cannot be heard, into a region outside of the entire instrument, so that only the active region acts as the sound-determining and tone-determining element of the instrument. The result is a more undistorted, clearer, and more dynamic primary sound event, free of any interferences and distortions that are necessarily present in a musical instrument in which no kinetic disposal has taken place. However, this means that in this process of kinetic disposal, none of the primary sound event is damped.

Kinetic disposal can also have a direct feedback effect on the active region. For example, the reed of a clarinet consists of an active (i.e. freely vibrating) region and a passive (i.e. firmly clamped) region. Kinetic disposal by means of the method according to the invention, by placement of a crystalline body according to the invention directly at the clamping point, reduces the feedback effects of subsequent vibration of the fixed clamped part

on the active region of the reed. As a result, the active region returns to its energy-optimal starting state as soon as possible, and superimpositions of sound events are avoided.

Kinetic disposal is also not damping of the secondary sound event, but rather direct, almost delay-free dissipation of the sound energy that has gotten into the passive region, before storage of this energy in the passive region and thus interferences with the primary sound event could come about.

In this connection, the crystalline bodies are disposed, as mentioned, in the passive region of the musical instrument, with the best positions for placement of the bodies being determined either in simulations or experimentally. In the case of a piano or grand piano, the placement locations can be in the box bracket, on the plate wedge that is situated between cast iron plate and box bracket, on the cast iron plate, on the legs, on the casters, etc.

Preferably, the crystalline body is a crystal having a high degree of crystalline order, and the best results can be achieved with monocrystals. Fundamentally, it holds true that the effect of the method according to the invention becomes all the greater, the higher the sound velocity in the crystal of the selected body. The more ordered and purer a crystal of a solid body, the greater the sound velocity in this body.

Materials that have the properties required for kinetic disposal in the sense of the invention are, for example, diamonds (natural or synthetic, having a cubic area-centered crystal structure and a sound velocity of approximately 18,000 m/s) or ceramic materials such as boron carbide, aluminum oxide, boron nitride, zirconium dioxide, or the like (having a sound velocity that is greater than 8,000 m/s).

In the simulations and test series conducted by the applicant, it was shown that the size of the crystalline body (i.e. its volume) does not have any influence on the effect of kinetic disposal that is achieved. With regard to the placement location of the crystalline bodies, the smallest possible, unnoticeable sizes should be aimed at, and these will preferably lie in the range of edge lengths and/or diameters of the body between several nanometers and several centimeters.

For the first time, the present invention describes ways and means, using kinetic disposal, how the primary sound event can be emitted without distortion and blurring as the result of interference caused by secondary sound events, in that the sound energy that is introduced into components in which it is not desired is immediately dissipated from them again, in order to avoid the energy storage effects that have been described, and the interference that results from them.

Further advantages of the invention are evident from the following description of an exemplary embodiment, using the attached figures. These show:

### BRIEF DESCRIPTION OF THE FIGURES OF THE DRAWINGS

FIG. 1, a three-dimensional representation of a grand piano as a possible musical instrument for use of the method according to the invention;

FIG. 2, a representation of the corpus of the grand piano shown in FIG. 1;

FIG. 3, the placement of a crystalline body, according to the invention, for kinetic disposal, on the box bracket of the grand piano shown in FIG. 1, with the crystalline body being set into a fitted bore;

FIG. 4, a representation as in FIG. 3, with the difference that here, the crystalline body is glued onto the planar surface;

FIG. 5, the placement, according to the invention, of a crystalline body on a rib of the cast iron plate, for kinetic disposal at this component;

FIG. 6, schematically, the progression (envelope curve) of the overall sound of a tone produced using a conventional instrument (sound event); and

FIG. 7, schematically, the progression (envelope curve) of the overall sound of a tone produced using an instrument that has been modified using the method according to the invention (sound event).

### WAY(S) FOR IMPLEMENTING THE INVENTION

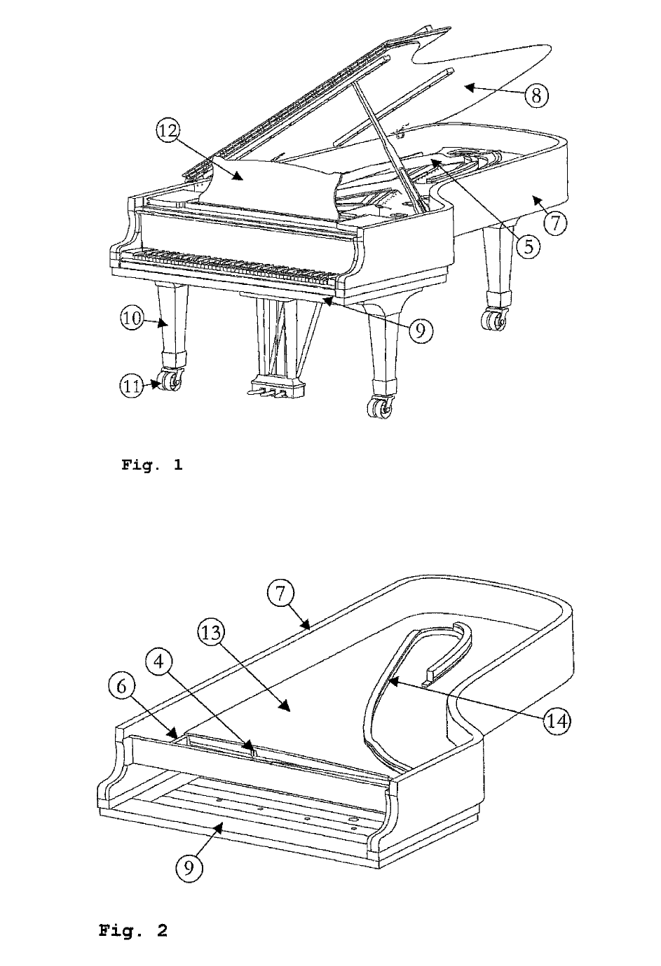

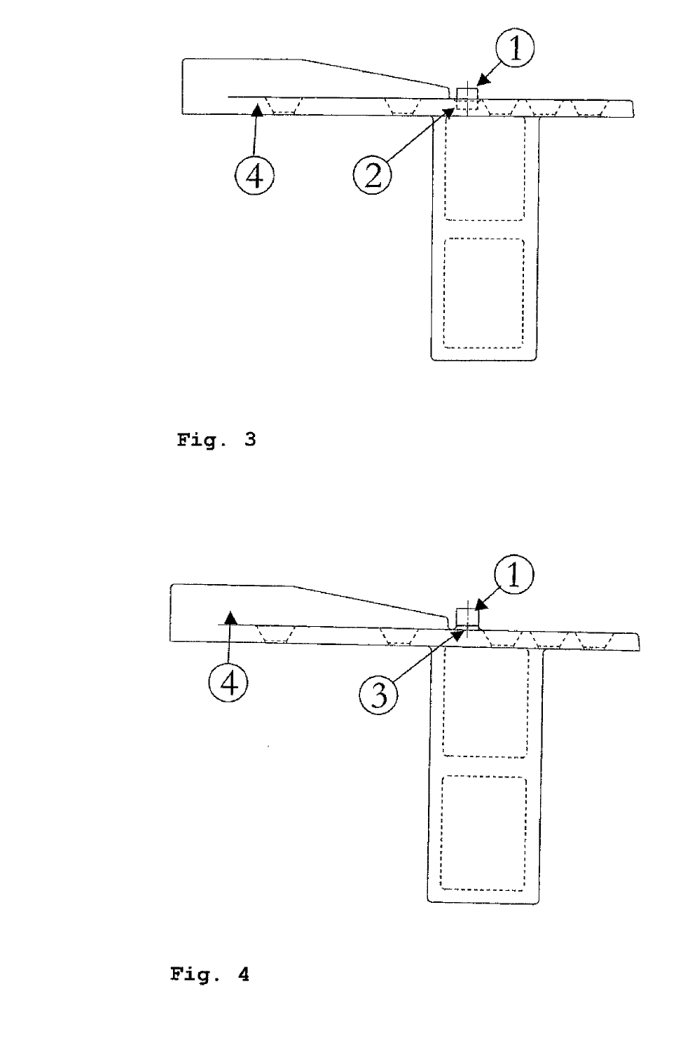

FIGS. 1 and 2 show a grand piano, i.e. its corpus, in isolated manner, as a possible musical instrument for use of the method according to the invention.

The grand piano consists of a central main component, the rim, consisting of the wall 7 and the frame 6, which is set up on legs 10 with casters 11 disposed on them, and closed off at the top side with a top 8. On the front of the rim, there is the keybed or console 9, on the underside, on which the mechanism required to strike the strings, consisting of a claviature (keyboard) and a mechanical system, is situated. In the rim, as the central component, there is the soundboard 13 that is glued onto the frame 6 and usually consists of spruce wood, with the cast iron plate 5 that lies above it, which usually consists of gray cast iron, onto which the strings are strung, and, underneath it, the ribs that reinforce the corpus. The connection between ribs and cast iron plate 5 consists of a box bracket 4; the connection of strings and soundboard 13 takes place by means of the bridge 14 that is firmly connected with the soundboard 13. In the front upper part of the grand piano, there is the note stand 12.

In the grand piano, only the following, active components are responsible for the actual production of the primary sound event, in other words for generating the tone: the strings, the bridge 4, and the soundboard 13. However, these parts are connected, in sound-conducting manner, with the other components, those of the passive region, such as the cast iron plate 5, the box bracket 4, the frame 6, the wall 7, and the legs 10.

In order to prevent energy storage effects that occur in these components of the passive region, and in the passive region of components that also have an active effect (are directly involved in the creation of the primary sound event), and to avoid secondary sound events that distort this primary sound event, as the result of interference with it, crystalline bodies 1 made of a material having a sound velocity in the solid body of more than 8,000 m/s, for example made of diamond, boron carbide, or the like, are disposed in the passive regions of the grand piano, according to the invention.

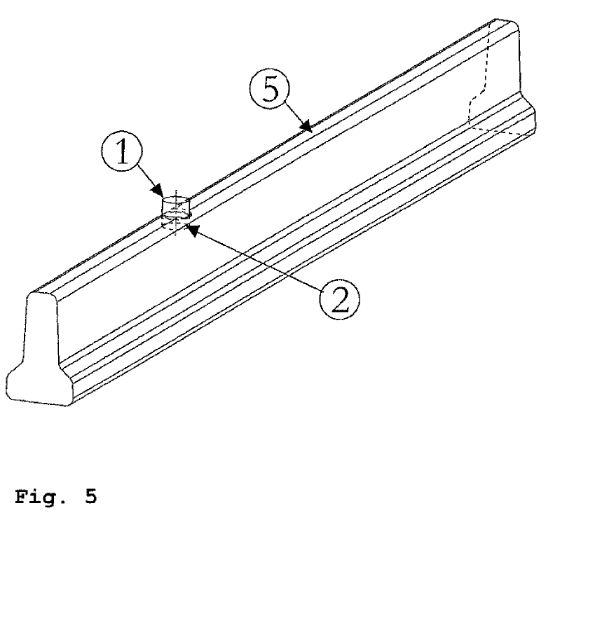

Such a crystalline body 1 must be connected with the section of the passive region for which kinetic disposal is required (e.g. with the box bracket 4, the top 8, or the cast iron plate 5, see FIGS. 3 to 5) in such a manner that direct, full-area contact with the component is produced on one side, and the other side lies free. This can be achieved, for example, by means of a countersunk bore in the form of a fitted bore 2 (see FIG. 3), or by means of a glued connection 3 on a planar surface (see FIG. 4).

The size, i.e. the volume of the crystalline body 1 applied for kinetic disposal is dependent, on the one hand, on the material used, as well as on the location of use, in each instance, and the other requirements, and can amount to from several nanometers to several centimeters in diameter.

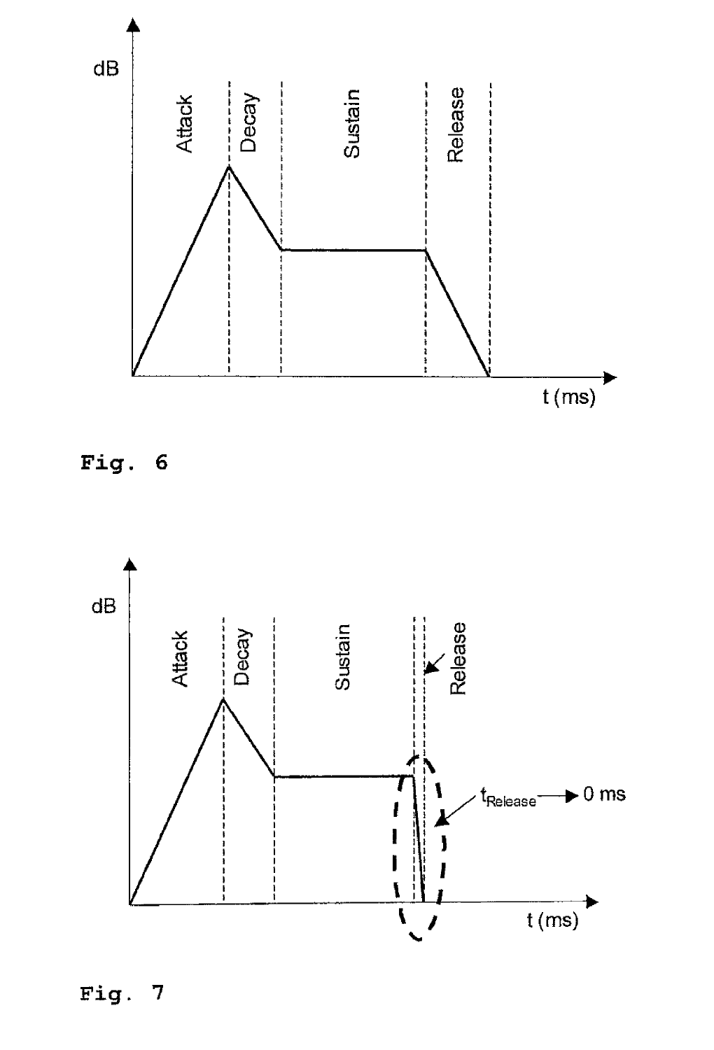

FIGS. 6 and 7 schematically show the effect of the method according to the invention on the overall sound of an instrument that has been treated, i.e. equipped accordingly.

In these figures, the time progression of the envelope curve of the overall sound of a sound event produced in an instrument having a conventional construction is shown in FIG. 6, and in FIG. 7, for an instrument having a construction modified according to the invention.

While in both cases, the buildup of sound in the phases “attack” and “decay” and the reverberation “sustain” are identical, the result achieved by the kinetic disposal described and the related elimination of energy storage effects is that the dying away of vibrations in the phase called “release” turns out to be clearly shorter, in a theoretical ideal case instantaneous. In other words, the dying-away time approaches 0 ms, as indicated in FIG. 7.

The method of functioning of the kinetic disposal for minimizing the influence of secondary sound events on the primary sound event was primarily described, here, using the construction of grand pianos and pianos. However, it can be transferred analogously to other musical instruments, as well:

Application Example for Kinetic Disposal in Wind Instruments and Organs:

The sound event of a wind instrument consists of a vibrating air column in the interior of a barrel. In this connection, the barrel should not influence the air column, since inherent vibrations of the barrel or the mouthpiece lead to interferences, and thus to distortions of the sound event. For this reason, it is also possible to provide kinetic disposal of the barrel/housing of a wind instrument, in the sense of this invention, in that the material (diamond, boron carbide, or the like) is connected with the barrel in sound-conducting manner, for example directly behind the mouthpiece, in the vicinity of the flare, or the like.

Application Example for Kinetic Disposal in Bowed and Plucked Instruments:

The primary sound event of a bowed and plucked instrument consists of a string that is put into vibration, which is coupled with a soundboard by way of a bridge. This soundboard amplifies the string sound. Here, vibrations of the passive components, such as the neck with the fingerboard, are undesirable. This neck can be provided with kinetic disposal, in the sense of the invention, also in the manner already described. The same holds true for the endpin of cello and contrabass.

Application Example for Kinetic Disposal of Vibration Exciters, Such as Hammer Shafts (Piano and Grand Piano), Bows (Bowed Instruments), Plectra (Plucked Instruments), Mallets and Sticks (Percussion Instruments), and the Like:

By means of triggering a sound event, the vibration exciter, in each instance, is also put into vibration. At the time of triggering the next sound event, energy of the preceding event can still be stored in the vibration exciter and exert a distorting influence on the subsequent event. Kinetic disposal takes place in the manner already described.

It is possible to proceed analogously with all other musical instruments: membranophones such as kettledrums and drums, in which the influence of housing or corpus vibrations on the membrane is minimized by means of kinetic disposal, as well as other percussion instruments, Orff instruments, vibraphones, marimbas, and many more.

Finally, in the case of use (not shown here) of the crystalline body for reducing the direct subsequent vibration of a component of a musical instrument that can be assigned both, on the one hand, to the active region, and, on the other hand, to the passive region (e.g. the reed of a woodwind instrument, which consists of an active, i.e. freely vibrating, and a passive, i.e. firmly clamped part), which vibration is implied directly, from the passive part, by means of feedback, this component must also be connected with the passive region of the component for which kinetic disposal is required, in such a manner that on the one side, direct, full-area contact with the component is produced, and the other side lies free.

In this connection, however, the position must be selected in such a manner that the desired vibration capacity of the component is not hindered. If the crystalline body is directly connected with the clamped region, in the case of a reed, for example, it does not hinder free vibration of the reed, but has a kinetic disposal effect. The reed therefore vibrates more freely, and the tone response is more direct.

### REFERENCE SYMBOL LIST

1 crystalline body
2 fitted bore
3 glued connection
4 box bracket
5 cast iron plate
6 frame
7 wall
8 top
9 keybed (console)
10 leg
11 caster
12 note stand
13 soundboard
14 bridge

1. A method for reducing sound emission and energy storage effects of the passive region of musical instruments, the method comprising disposing at least one crystalline body having a sound velocity in the solid body of more than 8,000 m/s on at least one component, connected in a substantially direct planar manner.

2. The method of claim 1, wherein the crystalline body is disposed on a component substantially uninvolved in the primary sound production, as a whole, and substantially non-requisite for sound production.

3. The method of claim 1, wherein the crystalline body is disposed in a passive region of a component having an active region substantially required for sound production and involved in the primary sound production.

4. The method of claim 1, wherein the at least one crystalline body comprises a crystal having a high level of crystalline order.

5. The method of claim 1, wherein the at least one crystalline body comprises a material selected from the group consisting of aluminum oxide (Al2O3), boron carbide, boron nitride, zirconium dioxide, and diamond.

6. The method of claim 1, wherein the edge dimensions of the at least one crystalline body lie in the range of several nanometers to several centimeters.

7. The method of claim 1, wherein the at least one crystalline body is glued onto the at least one component.

8. The method of claim 1, wherein the at least one crystalline body is set into the at least one component.

9. A method comprising using a crystalline body for influencing the sound of musical instruments wherein the crystalline body is directly connected, in planar manner, with the musical instrument, and has a sound velocity in the solid body of more than 8,000 m/s.

10. A musical instrument comprising a crystalline body having a sound velocity in the solid body of more than 8,000 m/s, directly connected, in a planar manner, with at least one of its components.

11. The method of claim 4, wherein the at least one crystalline body comprises a monocrystal.
